(19) United States
(12) Patent Application Publication
(10) Pub. No.: US 2021/0329755 A1
(43) Pub. Date: Oct. 21, 2021

(54) NAVIGATIONAL DYNAMIC LIGHTING

(71) Applicant: Dell Products L.P., Round Rock, TX (US)

(72) Inventors: Scott C. LAUFFER, Austin, TX (US); Matthew Bryan GILBERT, Austin, TX (US); Richard William GUZMAN, Austin, TX (US); Richard Andrew CRISP, Austin, TX (US); Sean P. O'DONNELL, Austin, TX (US)

(73) Assignee: Dell Products L.P., Round Rock, TX (US)

(21) Appl. No.: 16/850,180

(22) Filed: Apr. 16, 2020

(51) Int. Cl. H05B 45/20; H05B 45/10; G08B 5/36; H05B 47/19

(52) U.S. Cl. CPC H05B 45/20; H05B 45/10; F21Y 2115/10; H05B 47/19; G08B 5/36

(57) ABSTRACT

An information handling system may include at least one processor and a plurality of indicator lights. The at least one processor may be configured to detect a fault condition associated with a particular information handling resource located at a particular physical location, and cause at least some of the plurality of indicator lights to be illuminated in a determined sequence based on the physical location, wherein the determined sequence is configured to cause a dynamic visual illumination that is directed toward the physical location.

### TECHNICAL FIELD

The present disclosure relates in general to information handling systems, and more particularly to creating dynamic lighting patterns to assist in navigation toward a faulty component.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Particularly in large information handling systems, it can be difficult to locate a component that has encountered a fault condition. For example, if a given hard drive fails in a system that includes a large number of hard drives, the failed drive may conventionally indicate the fault by illuminating an indicator light, changing a color of an indicator light, etc. But the remaining hard drives will typically also have other indicator lights illuminated to indicate normal operation, and within a large number of such lights, it may not be immediately obvious which drive has failed. This type of problem is known at various scales, from identifying a particular hard drive within a single server or storage system, to identifying a particular server within a rack, to identifying a particular rack within a datacenter, etc.

Accordingly, embodiments of this disclosure provide ways to assist navigation by illuminating indicator lights in a determined sequence, such that a dynamic visual illumination is created that is directed toward the physical location of a faulty component.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with navigating to a faulty component may be reduced or eliminated.

In accordance with embodiments of the present disclosure, an information handling system may include at least one processor and a plurality of indicator lights. The at least one processor may be configured to detect a fault condition associated with a particular information handling resource located at a particular physical location, and cause at least some of the plurality of indicator lights to be illuminated in a determined sequence based on the physical location, wherein the determined sequence is configured to cause a dynamic visual illumination that is directed toward the physical location.

In accordance with these and other embodiments of the present disclosure, a method may include a processor detecting a fault condition associated with a particular information handling resource located at a particular physical location in an information handling system comprising a plurality of indicator lights; and the processor causing at least some of the plurality of indicator lights to be illuminated in a determined sequence based on the physical location, wherein the determined sequence is configured to cause a dynamic visual illumination that is directed toward the physical location.

In accordance with these and other embodiments of the present disclosure, an article of manufacture may include a non-transitory, computer-readable medium having computer-executable code thereon that is executable by a processor for: detecting a fault condition associated with a particular information handling resource located at a particular physical location in a system including a plurality of indicator lights; and causing at least some of the plurality of indicator lights to be illuminated in a determined sequence based on the physical location, wherein the determined sequence is configured to cause a dynamic visual illumination that is directed toward the physical location.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow diagram of an example method, in accordance with embodiments of the present disclosure;

FIG. 3 illustrates an example illumination pattern, in accordance with embodiments of the present disclosure;

FIG. 4 illustrates a flow diagram of an example method, in accordance with embodiments of the present disclosure;

FIG. 5 illustrates an example datacenter, in accordance with embodiments of the present disclosure; and

FIG. 6 illustrates a flow diagram of an example method in accordance with embodiments of the present disclosure.

### DETAILED DESCRIPTION

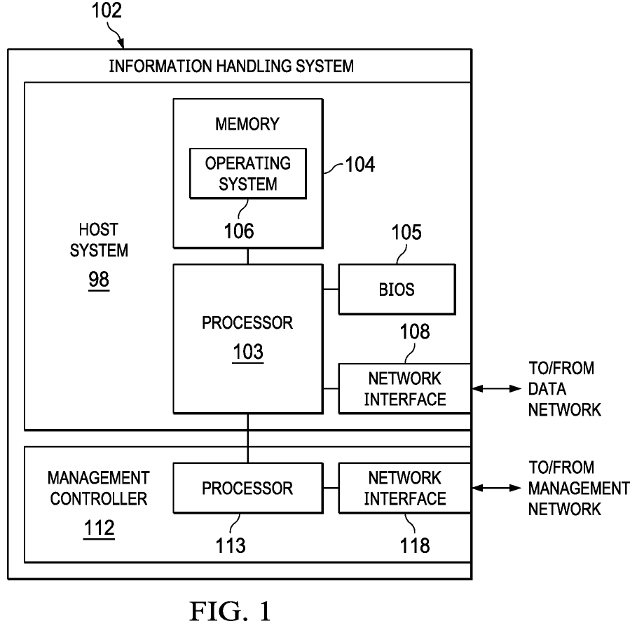

Preferred embodiments and their advantages are best understood by reference to FIGS. 1 through 6, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

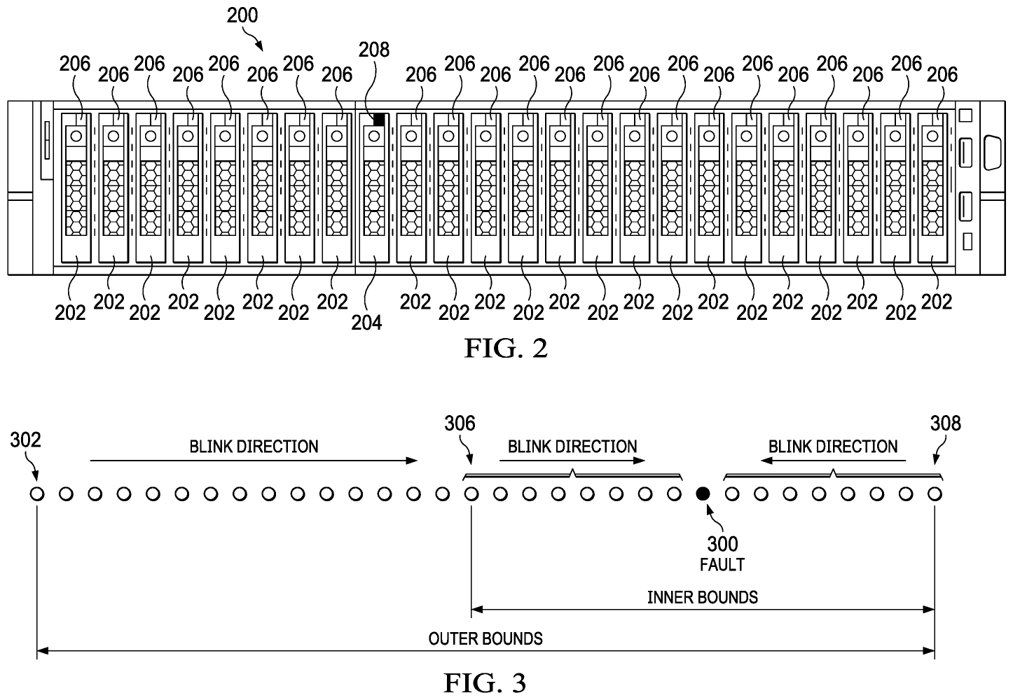

As noted above, if a particular information handling resource in a large system has encountered a fault, it can be difficult to locate that resource. FIG. 2 shows an example system 200 illustrating such difficulty.

System 200 includes a plurality of physical storage resources 202 that are operating normally, as shown by their indicator lights 206. One physical storage resource 204, however, has encountered a fault. This may be indicated by indicator light 208 illuminating in a different color, blinking, etc. The various indicator lights may comprise light-emitting diodes (LEDs) or any other suitable type of light.

Indicator light 208 may be difficult to identify visually in the context of the other indicator lights 206. This problem may be further exacerbated in a rack-mounted system including a plurality of systems 200.

Accordingly, an information handling system such as information handling system 102 may be used to control the various indicator lights in order to assist with navigation toward the faulted component.

For example, processor 103 or processor 113 of management controller 112 may be communicatively coupled to various indicator lights. In some cases, indicator lights may be components of other information handling resources (such as physical storage resources), and they may be controlled via a connection to such information handling resources. In other cases, indicator lights may be add-on components that are controlled directly. Generally speaking, the indicator lights may be activated in a pattern that causes a dynamic visual illumination (e.g., an “animation”) that is directed toward the physical location of the fault. In some embodiments, only some subset of the available indicator lights may be used to form the dynamic visual illumination. In such embodiments, it may be advantageous to disable some other subset of the available indicators, to further highlight the dynamic visual illumination.

Turning now to FIG. 3, an example of such a pattern is illustrated. A fault is detected at location 300, and it may be desirable to have the available indicator lights turn on and off, and/or fade brighter and dimmer, and/or change colors, in a pattern that converges on location 300. Throughout this disclosure, the term “blink pattern” may be understood to refer to any of such patterns or any combination of such patterns.

In this example, locations 306 and 308 are equidistant from location 300. Starting at location 302, a blink pattern may be enacted that indicates a rightward direction. For example, the indicator lights may sequentially turn on and then off, one at a time, in a sequence that proceeds to the right. Or in other embodiments, the indicator lights may sequentially turn on, but several of the lights may remain on at the same time, and then turn off sequentially. Or in yet other embodiments, the indicator lights may sequentially turn on and remain on, and then eventually may all turn off simultaneously.

When the blink pattern reaches location 306, which is symmetric with location 308 about the fault location 300, a similar blink pattern may begin at location 308 but proceeding to the left, such that the two patterns converge simultaneously to location 300 of the fault.

In some embodiments, this blink pattern may be initiated as soon as the fault is detected and may persist until the fault is remedied. In other embodiments, the blink pattern may not be initiated until a person is detected in proximity (e.g., within 10 feet) of the system.

A person's proximity may be detected in various ways. In various embodiments, cameras, infrared sensors, Bluetooth transceivers, and rack door sensors may be used (singly or in combination) to determine the presence of an individual.

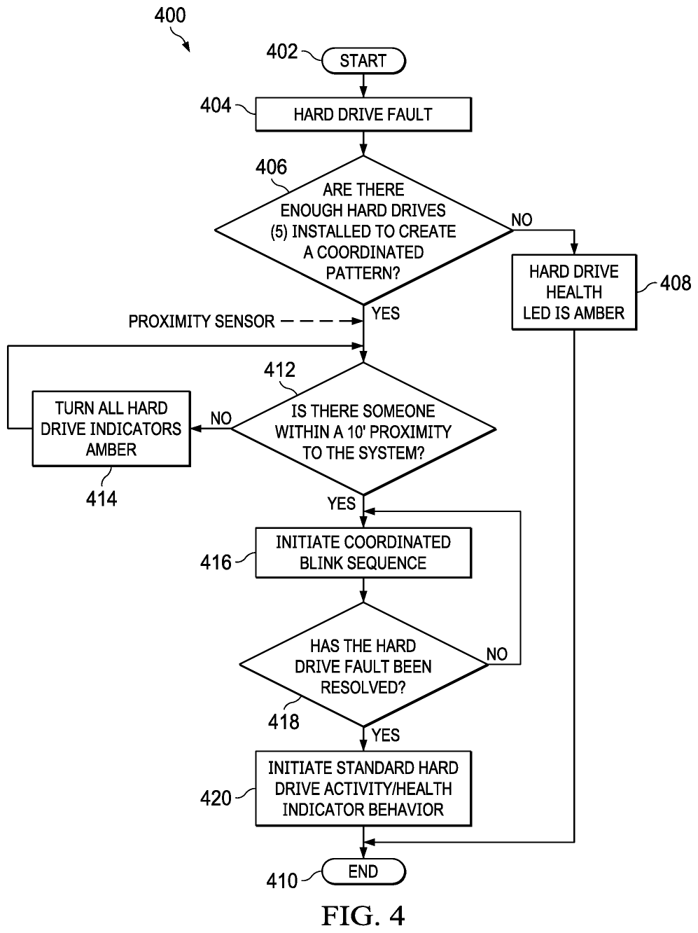

Turning now to FIG. 4, a flow chart is shown of an example method 400 for navigational dynamic lighting, according to some embodiments.

The method may begin at step 402. At step 404, a fault may be detected in a physical storage resource (e.g., a hard drive). At step 406, a determination may be made regarding how many hard drives are installed in the system.

If there are fewer than some threshold number of hard drives (e.g., 5), then navigational dynamic lighting may not be needed. In that situation, the method may proceed to step 408 to turn the health light for the affected hard drive amber, and the method may end at step 410.

If, on the other hand, a large number of hard drives are installed, the method may proceed to step 412.

At step 412, a determination may be made (e.g., based on one or more proximity sensors) whether a person is in proximity to the system. If not, at step 414, all of the hard drive indicator lights may be turned amber, and the method may enter a loop to wait for an individual to approach the system.

At step 416, when an individual is detected, a coordinated blink sequence may be engaged. Until the fault has been resolved, the method may loop at step 418 to continue the coordinated blink sequence. Once the fault is resolved, normal indicator light behavior may be resumed at step 420, and the method may end.

One of ordinary skill in the art with the benefit of this disclosure will understand that the preferred initialization point for the method depicted in FIG. 4 and the order of the steps comprising that method may depend on the implementation chosen. In these and other embodiments, this method may be implemented as hardware, firmware, software, applications, functions, libraries, or other instructions. Further, although FIG. 4 discloses a particular number of steps to be taken with respect to the disclosed method, the method may be executed with greater or fewer steps than those depicted. The method may be implemented using any of the various components disclosed herein (such as the components of FIG. 1), and/or any other system operable to implement the method.

As noted above, such coordinated blink sequences need not be limited to individual information handling resources within a single system. They may also be used to indicate a particular information handling system within a rack of information handling systems, and/or even a particular rack within a datacenter environment. As one of ordinary skill in the art with the benefit of this disclosure will appreciate, datacenter-level embodiments, rack-level embodiments, and/or system-level embodiments may be combined as desired in any given implementation.

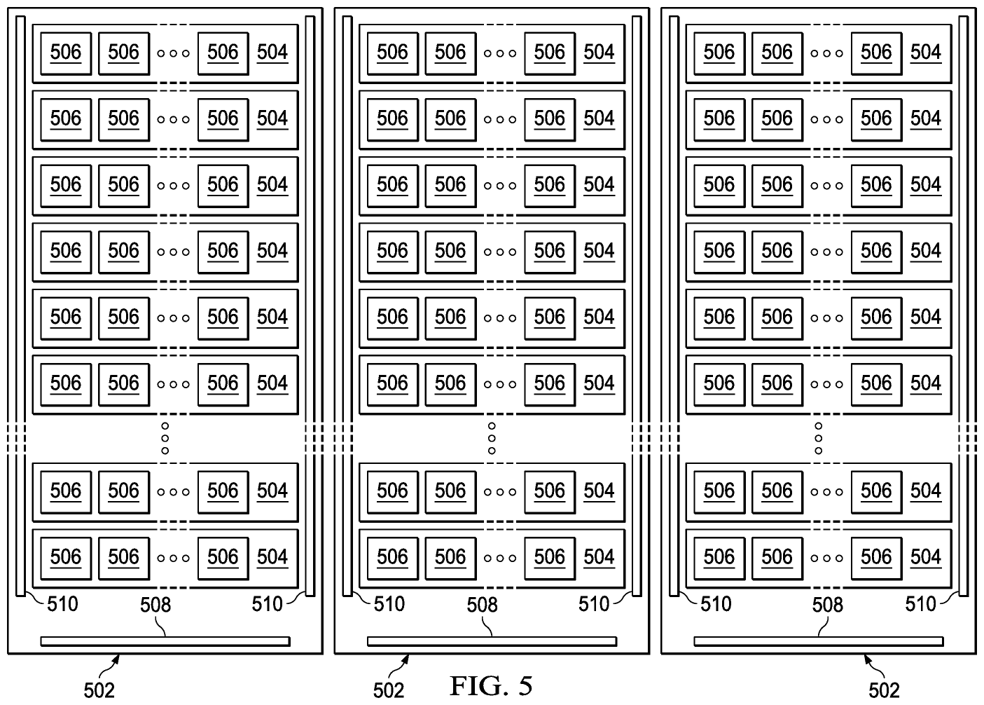

FIG. 5 illustrates a datacenter environment including a plurality of server racks 502. Each rack 502 is shown as including a plurality of information handling systems 504, which each respectively include a plurality of information handling resources 506. Each information handling resource 506 may include one or more indicator lights (not shown) as described above with respect to FIG. 2.

One of ordinary skill with the benefit of this disclosure will understand that in practice, the actual numbers of racks 502, information handling systems 504 and information handling resources 506 may vary. Further, each information handling system 504 may include different numbers and types of information handling resources 506. Further, each information handling system 504 may be sized differently (e.g., they may occupy differing numbers of rack units within the racks 502).

In this embodiment, each rack 502 may include a footer indicator light 508 at the floor, and one or more vertical indicator lights 510. In some embodiments, footer indicator lights 508 and vertical indicator lights may include a plurality of individual lights such as LEDs, so that selected portions may be illuminated, faded, and/or colored independently of other portions. In some embodiments, they may comprise light bars that may have portions that may be activated selectively.

If a particular information handling resource 506 encounters a fault, it may be difficult or time-consuming for a technician to locate that particular resource among all the others shown.

In order to guide a technician to a particular rack 502, footer indicator lights 508 may engage in a blink pattern similar to the blink patterns described above. Once the technician has reached the correct rack, vertical indicator lights 510 may also engage in a blink pattern to guide the technician to the correct information handling system 504. Additionally, the indicator lights of that information handling system may guide the technician to the correct information handling resource 506. All of these different levels of navigational aid may occur at the same time or in sequence as the user approaches the correct location.

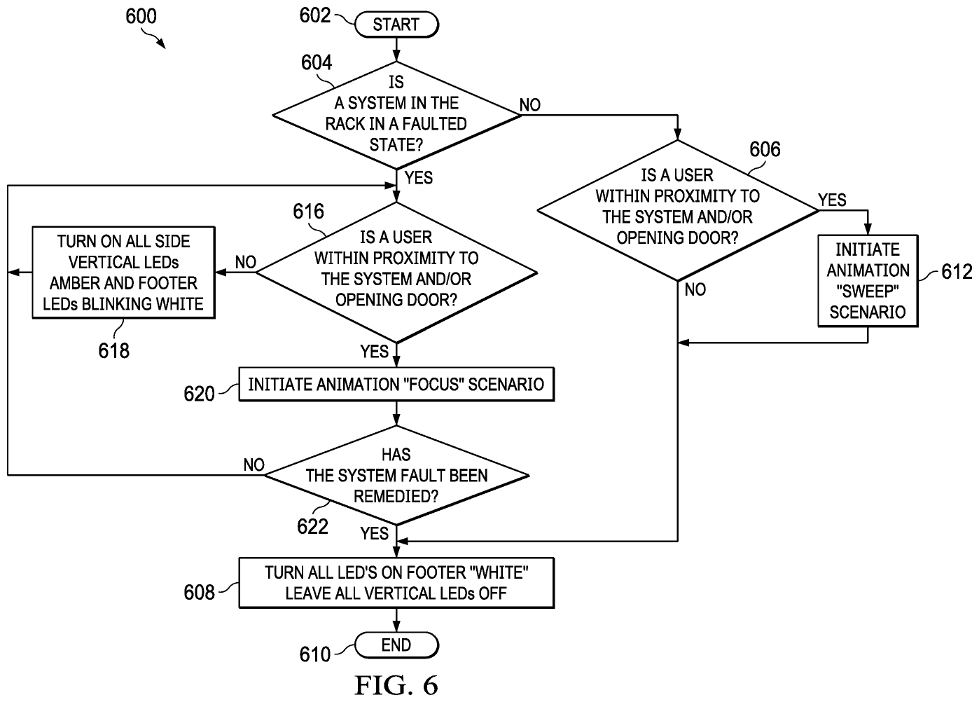

Turning now to FIG. 6, a flow chart is shown of another example method 600 for navigational dynamic lighting, according to some embodiments. This method provides one particular example of the types of lighting control that may be used in accordance with this disclosure.

The method may begin at step 602. At step 604, a processor may determine whether any system in the rack is in a faulted state.

If not, at step 606, the processor may determine whether a user is in proximity to the rack and/or has opened the rack door. If not, the processor may cause the indicator lights of the rack to enter a default state at step 608, in which the vertical indicator lights are off and the footer lights are illuminated in white.

If the system is not in a faulted state but a user is in proximity, at step 612, a sweep animation may be initiated to acknowledge the presence of the user. For example, the vertical indicator lights may illuminate in blue, starting at the bottom of the rack, sweeping upward and then downward. After the sweep animation completes, at step 614, the system may enter the default state at step 608.

If the system is in a faulted state, the processor may determine at step 616 whether a user is in proximity to the rack and/or has opened the rack door. If the user is not present, at step 618 the method may loop while it waits for a user to arrive, blinking the footer lights in white, and illuminating the vertical lights in amber. In other embodiments, the lights of the individual rack containing the fault may be coordinated with other racks, causing the footer lights of several racks to engage in a blink pattern that converges on the faulted rack.

Once a user is in proximity, at step 620, the processor may initiate a focus animation to draw the user's attention to the correct location. The focus animation may include causing the vertical lights to illuminate in a pattern that converges on the faulted system (e.g., similar to the type of pattern discussed above with regard to FIG. 3, but at the system level instead of the component level). In some embodiments, within the faulted system, individual lights associated with individual information handling resources may also animate in a pattern that converges on the location of the faulted component.

At step 622, the method may loop back to step 616 until the fault is remedied. Once the fault is remedied, the method may enter the default state at step 608.

The method may then end at step 610.

In some implementations, the rack-level and/or datacenter-level embodiments disclosed herein may operate based on a one-to-many management system. For example, individual management controllers within each information handling system in a rack (or within each of several racks) may be communicatively coupled to such a one-to-many management system and may provide information regarding failures. The one-to-many management system may then send operational instructions to one or more lighting control subsystems, which may include circuitry used to drive the actual indicator lights.

One of ordinary skill in the art with the benefit of this disclosure will understand that the preferred initialization point for the method depicted in FIG. 6 and the order of the steps comprising that method may depend on the implementation chosen. In these and other embodiments, this method may be implemented as hardware, firmware, software, applications, functions, libraries, or other instructions. Further, although FIG. 6 discloses a particular number of steps to be taken with respect to the disclosed method, the method may be executed with greater or fewer steps than those depicted. The method may be implemented using any of the various components disclosed herein (such as the components of FIG. 1), and/or any other system operable to implement the method.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

The FIGURES may not be drawn to scale in some embodiments. In other embodiments, however, they may be drawn to scale.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a plurality of indicator lights;
wherein the at least one processor is configured to:
detect a fault condition associated with a particular information handling resource located at a particular physical location; and
cause at least some of the plurality of indicator lights to be illuminated in a determined sequence based on the physical location, wherein the determined sequence is configured to cause a dynamic visual illumination that is directed toward the physical location.

2. The information handling system of claim 1, wherein the indicator lights comprise light-emitting diodes (LEDs).

3. The information handling system of claim 1, wherein the at least one processor is a component of a management controller that is configured to provide out-of-band management of the information handling system.

4. The information handling system of claim 1, wherein the plurality of indicator lights are associated with a respective plurality of information handling resources, and wherein the particular information handling resource is one of the plurality of information handling resources.

5. The information handling system of claim 4, wherein the plurality of information handling resources are physical storage resources.

6. The information handling system of claim 5, wherein each physical storage resource includes a plurality of indicator lights, and wherein the at least one processor is configured to deactivate a first subset of the plurality of indicator lights and cause the dynamic visual illumination via a second subset of the plurality of indicator lights.

7. The information handling system of claim 1, wherein the plurality of indicator lights are associated with a respective plurality of information handling systems within a rack, and wherein the particular information handling resource is associated with one of the plurality of information handling systems, such that the dynamic visual illumination is directed toward the one of the plurality of information handling systems.

8. The information handling system of claim 1, wherein the plurality of indicator lights are associated with a respective plurality of racks of information handling systems within a datacenter, and wherein the particular information handling resource is associated with one of the plurality of racks, such that the dynamic visual illumination is directed toward the one of the plurality of racks.

9. A method comprising:
a processor detecting a fault condition associated with a particular information handling resource located at a particular physical location in an information handling system comprising a plurality of indicator lights; and
the processor causing at least some of the plurality of indicator lights to be illuminated in a determined sequence based on the physical location, wherein the determined sequence is configured to cause a dynamic visual illumination that is directed toward the physical location.

10. The method of claim 9, wherein causing the at least some of the plurality of indicator lights to be illuminated in the determined sequence comprises causing selected indicator lights to be activated and deactivated.

11. The method of claim 9, wherein causing the at least some of the plurality of indicator lights to be illuminated in the determined sequence comprises causing selected indicator lights to change their respective colors.

12. The method of claim 9, wherein causing the at least some of the plurality of indicator lights to be illuminated in the determined sequence comprises causing selected indicator lights to change their respective brightness levels.

13. An article of manufacture comprising a non-transitory, computer-readable medium having computer-executable code thereon that is executable by a processor for:
detecting a fault condition associated with a particular information handling resource located at a particular physical location in a system including a plurality of indicator lights; and
causing at least some of the plurality of indicator lights to be illuminated in a determined sequence based on the physical location, wherein the determined sequence is configured to cause a dynamic visual illumination that is directed toward the physical location.

14. The article of claim 13, wherein the code is further executable for:
detecting that an individual is within a threshold proximity of the system; and
causing the at least some of the plurality of indicator lights to be illuminated in the determined sequence based on the detection of the individual.

15. The article of claim 14, wherein the detection of the individual is based on a proximity sensor selected from the group consisting of cameras, infrared sensors, Bluetooth transceivers, and rack door sensors.

16. The article of claim 13, wherein the plurality of indicator lights are associated with a respective plurality of information handling systems within a rack, and wherein the particular information handling resource is associated with one of the plurality of information handling systems, such that the dynamic visual illumination is directed toward the one of the plurality of information handling systems.

17. The article of claim 16, wherein the processor is associated with a one-to-many management system that is configured to receive information from a plurality of management controllers associated with each of the plurality of information handling systems within the rack, and further configured to cause the at least some of the plurality of indicator lights to be illuminated in the determined sequence via the plurality of management controllers.

18. The article of claim 13, wherein the plurality of indicator lights are associated with a respective plurality of racks of information handling systems within a datacenter, and wherein the particular information handling resource is associated with one of the plurality of racks, such that the dynamic visual illumination is directed toward the one of the plurality of racks.

19. The article of claim 18, wherein the processor is associated with a one-to-many management system that is configured to receive information from a plurality of management controllers associated with each of the plurality of racks, and further configured to cause the at least some of the plurality of indicator lights to be illuminated in the determined sequence via the plurality of management controllers.

20. The article of claim 13, wherein the code is further executable for:
in an absence of a fault condition, causing the plurality of indicator lights to be illuminated in a different sequence.
